(19) United States
(12) Patent Application Publication
(10) Pub. No.: US 2026/0162879 A1
(43) Pub. Date: Jun. 11, 2026

(54) ORTHOGONAL JOINED PLATE WINDINGS FOR TOROIDAL MAGNETICS

(71) Applicant: Tesla, Inc., Austin, TX (US)

(72) Inventors: William Thomas Chi, Fremont, CA (US); Huan Zhang, Santa Clara, CA (US); Balaji Narayanasamy, Mountain View, CA (US); Mehmet Ozbek, San Francisco, CA (US); Rameez Hasan, San Leandro, CA (US); Todor Mihaylov, Austin, TX (US)

(21) Appl. No.: 19/109,948

(22) PCT Filed: Sep. 28, 2023
(86) PCT No.: PCT/US2023/033938

§ 371 Date: Mar. 7, 2025

Related U.S. Application Data
(60) Provisional application No. 63/377,602, filed on Sep. 29, 2022.

(51) Int. Cl. H01F 27/30; H01F 17/06; H01F 27/28

(52) U.S. Cl. CPC H01F 27/306; H01F 17/062; H01F 27/2847; H01F 27/2895

(57) ABSTRACT

A electromagnetic core and winding assembly is proposed. The assembly may include a core comprising a body and. an aperture defined, by an inner surface of the body. The assembly may also include a plurality of plate windings configured to electromagnetically operate with the core, the plurality of plate windings disposed to cross and at least partially surround the body of the core. A portion of each of the plurality of plate windings may pass through the aperture of the core. The plurality of plate windings may at least partially orthogonally surround the body of the core.

### BACKGROUND

### Technical Field

The present disclosure relates to orthogonal joined plate windings for toroidal magnetics.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates an example orthogonal plate toroidal winding assembly according to some embodiments.

FIG. 2 is an electrical 3D model view of the orthogonal plate toroidal winding assembly of FIG. 1 according to some embodiments.

FIGS. 3A-3D illustrate another example orthogonal plate toroidal winding assembly according to some embodiments.

FIGS. 4A-4G illustrate steps in a process of how plates are combined with a core housing into a core winding assembly according to some embodiments.

FIGS. 5A-SD are different views of the core winding assembly of FIG. 3D according to some embodiments.

FIG. 6A illustrates alternative edge-to-edge butt weld joints where the plates are combined according to some embodiments.

FIG. 6B illustrates a sectional image for an example conversational, spatial understanding core, housing, U-busbar tight fitment according to some embodiments.

FIG. 6C illustrates types of welding joints according to some embodiments.

FIGS. 7A-7C illustrate example existing magnetic core materials made by plate stamping methods.

FIGS. 7D and 7E illustrate an example of progressive plate stamping formats of conductor according to some embodiments.

FIGS. 8A and 8B illustrate example orthogonal plate toroidal winding assemblies having different numbers of parts and unique part shapes according to some embodiments.

FIG. 8C illustrates that conductor stampings may be augmented by stacking and connecting other stampings which may be partial or fully sized to double or multiply local current ampacity, reduce electrical resistance, and enhance thermal pathways for the conductor according to some embodiments.

FIGS. 9A and 9B illustrate an example welding and fixturing method for welding the plates according to some embodiments.

FIGS. 10A-10C illustrate another example welding method for welding the plates according to some embodiments.

FIGS. 11A and 11B illustrate another example orthogonal plate toroidal winding assembly where exposed support or electrical connection points are staggered to prevent electrical shorting. Stampings may be insulated from one another by other dielectric materials such as sheets or films that are individual components separate from core structure according to some embodiments.

FIG. 11C illustrates a comparative example core winding assembly having a winding disposed in only one side of the core.

FIG. 11D illustrates another example orthogonal plate toroidal winding assembly which may have windings above, below, or alongside one another according to some embodiments.

FIG. 11E is a cross-sectional view of the orthogonal plate toroidal winding assembly of FIG. 11D according to some embodiments.

FIGS. 11F and 11G are respectively enlarged views of FIGS. 11B and 11C.

FIGS. 12A and 12B show how an example orthogonal plate toroidal winding assembly may present surfaces designated to serve as grip area for automated gripper according to some embodiments.

FIGS. 13A and 13B show an example PCB layout where example orthogonal plate toroidal winding assemblies are disposed according to some embodiments.

FIG. 13C shows a portion of FIG. 13B where transparent PCB view and heat dissipation cutouts are highlighted according to some embodiments.

FIG. 14 illustrates another example orthogonal plate toroidal winding assembly including a staggered lead design according to some embodiments.

FIG. 15A is a top view of an example orthogonal plate toroidal winding assembly installed in a PCB according to some embodiments.

FIG. 15B is a front view of the orthogonal plate toroidal winding assembly of FIG. 15A according to some embodiments.

FIG. 15C is a bottom view of the orthogonal plate toroidal winding assembly of FIG. 15A according to some embodiments.

FIGS. 15D and 15E are side views of the orthogonal plate toroidal winding assembly of FIG. 15A according to some embodiments.

FIG. 16A illustrates a standalone choke design according to some embodiments.

FIGS. 16B-16D illustrate how a connector is integrated into the orthogonal plate toroidal winding assembly according to some embodiments.

FIG. 16E illustrates busbars that are used as connector terminals insert molded in the housing according to some embodiments.

FIG. 16F illustrates an internal ribbon based nanocrystalline core embedded inside the enclosure according to some embodiments.

FIG. 16G illustrates how to adjust the way the power flows across the choke in the orthogonal stamping according to some embodiments.

FIG. 17A and FIG. 17B illustrate how the connector housing with insert molded terminals is supplied to the core assembly housing according to some embodiments.

FIG. 17C illustrates how the choke core and the housing are assembled according to some embodiments.

FIGS. 17D-17F illustrate how the rest of the winding structure is assembled to the main housing according to some embodiments.

FIG. 18A shows U-busbars assembled in which a connector tab growth for connector insertion is to be installed according to some embodiments.

FIG. 18B shows U-busbars installed directly over the core assembly housing according to some embodiments.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided herein are various embodiments of orthogonal joined plate windings for toroidal magnetics including separated vertical plate stacks that can enable several advantages to replace pulled round enameled magnet wires for toroidal windings in magnetic components like inductors, chokes, and transformers. Some embodiments include an electromagnetic core and winding assembly that includes a core and a plurality of plate windings orthogonally surrounding the core.

Various embodiment can provide one of more of the following non-limiting electrical and mechanical advantages including, but not limited to: 1) total footprint size reduction as compared to a continuous wire wound or flat wire edge wound toroidal core, 2) rectangular or favorable footprint shape desired for printed circuit board (PCB) components for optimal layout density, 3) winding plates being doubled as heatsink fins for natural convection cooling, 4) tunable turn-to-turn capacitance, 5) winding to winding surface creepage control, 6) controlled winding spacings for uniformity not subject to a wound wire pattern, wire tension effects, and bunching variability, 7) joining techniques such as laser welding providing manufacturing cycle times in mere seconds, 8) vertical plate ends acting as PCB solder leads or feet that can eliminate a round magnet wire terminal typically necessary to convert wire end to become suitable for connection to surface mount technology (SMT) foot and other printed-circuit board connection methods, and, 9) conductor plate thickness, cross-section and aspect ratio, and overall assembly shape may easily scaled for higher ampacity, thermal dissipation, low electrical and thermal resistance, inter-and intra-winding capacitance, among other desired objectives for the assembly.

Existing toroidal windings are predominantly hand-pulled enameled wire constructions, sometimes semi-automated. For example, continuous edge-wound flat copper can be spiraled into a toroidal core shape to install. Example winding toroid shapes may be formed by enameled wires drawn through and wrapped around by hand and/or machine, and the wires may physically contact a core, thus both core and wire are both susceptible to damage. Furthermore, high current applications may employ or require multiple parallel windings such as a bifilar winding arrangement which often requires sequentially wrapping successive lengths of wire conductor attempting to follow and match path and pitch spiraling around the core. Variable wire positioning and overall wire wound components in industrial practice can variably increase the shape and size of the core winding assembly resulting in irregularities when compared to one another.

Non-round spirals may be threaded onto a closed toroid. However, the ability to fit tightly is reduced due to assembly requiring spiral rotation onto toroid cross-section shape. Most cores are manufactured with constant rectangular sectional shape for microstructural uniformity and some particular cores such as nanocrystalline types are made up of fixed-width ribbons wrapped continuously layer upon layer (like a spool of a tape) and thus have a rectangular cross-section with sharp corners as shown in FIG. 2D. In the FIG. 2D design, an edgewise-wound or wire-wound conductors challenging to bend or conform to such sharp corners due to minimum inner bend radius of the conductor.

According to various embodiments, the size of a cross section of the core can be large without increasing the length of the total windings in each winding unit. For example, plates perpendicularly oriented to core equator arranged in parallel fashion and joined form an unconventional spiral winding structure. Thin plate conductors allow aspect ratios rivalling round, square, and flat magnet wire windings since they can stack onto or file alongside one another along a toroid shape and are not limited in size radially nor vertically along axis of core. As such, a wide customizable range of conductor sectional areas including non-uniform sectional areas and aspect ratios as desired can be achieved with little to no effect on a toroid size. Such winding shape customization may be for various combined purposes such as heat rejection, surrounding field effects, electrical interfaces, strength, stiffness, current flow of winding, and heat flow along portions of winding. A thermal benefit of plate-like conductors is that they behave like heat sink fins for convective heat transfer, or conductive edge-cooling methods are possible as well. Plates may be shaped to follow core contours as well as an external envelope. This optimized fitment is advantageous compared to edgewound spiral windings which must be spiral threaded onto toroids of a rectangular section, or the toroidal core must be cut to assemble rectangular formed wire spirals. The shape matching orthogonal plates allows an optimization of an overall footprint and volume for magnetic components such as chokes, inductors, or transformers. This level of volume optimization is not presently available for this type of wound component. Plate elements may be joined using processes such as laser-welding and allowed to have distinct shapes and thicknesses-even within a continuous single winding depending on the embodiment.

According to some embodiments, orthogonal conductor plates can provide one or more the following additional benefits. It is possible to implement direct soldering of edges of plates onto the surface of a PCB for electrical connection and/or mechanical and/or thermal interface. Each winding turn can have a proximate cooling path to the PCB surface, and optional PCB cutouts can allow thermal interface to cooling each winding from underside heatsink. A plate structure can be similar to convection heatsink for cooling. Plates may be shape for customized mounting, cooling, and conductor cross-sectional optimizations (geometric, resistance, thermal) within a dimensional envelope. Plate to plate/turn to turn capacitance can be tuned by a surface area and/or pitch spacing. Plates and subsections of plates may be stacked together and welded to double/triple/multiply conductive cross-section locally or completely. Turn to turn electrical isolation can be achieved by housing combs having a variable thickness and spacing or grooves added for desired electrical surface creepage as well. Conductors extending to a PCB can be fabricated and handled as a flat regularly shaped object, unlike magnet wires, and more suitable for automated assembly. Location of leads and weld joints can be fixed and reduce distortion and variability for high-volume automated PCB assembly (PCBA) production considerations.

Controlled plate spacings can eliminate need for magnet wire enameling which typically assumes insulation coated conductors are contacting and laying directly upon or alongside one another.

A novel cross-over link can enable power flow entering a toroid winding to exit through an opposite side without PCB interaction and can have electromagnetic compatibility (EMC) immunity benefits. Some embodiments allow many ways to customize a design within a rectangular footprint, spatial volume, planar cooling paths, and electrical layout or straightforward power flow simplification unavailable by conventional wire and edge-wound constructions.

Some embodiments can be applied to one or more of EMC chokes, conductors, transformers, or current sensors. Other benefits can be realized in through-hole, pin-in-paste, and SMD lead constructions. Some embodiments can also be applied to a molded housing for surface mount device (SMD) applications that require high-temperature grade resins to hold shape during solder/reflow. Some embodiments can also be applied to industrial development of a fully-automated assembly (comb insertion, fixturing, laser-welding) required for cost-competitiveness and manufacturing speed. Furthermore, some embodiments can also be applied to replace an edgewound conductor that requires inside bend radii which cannot follow a sharp cross-sectional shape of nanocrystalline cores made from a fixed width ribbon.

According to some embodiments, orthogonally arranged conductor can add a multitude of dimensional customizations for high density. Furthermore, novel cross-over conductors can enable new straight power flow-through. With orthogonal plates, the cross-over conductor can be naturally similar to other winding elements in terms of structure, handling, and implementation. Some embodiments can enable wound core assemblies meeting spatial density comparable to other SMD componentry (previously such assemblies would be off-PCBA with other electrical and mechanical mounting).

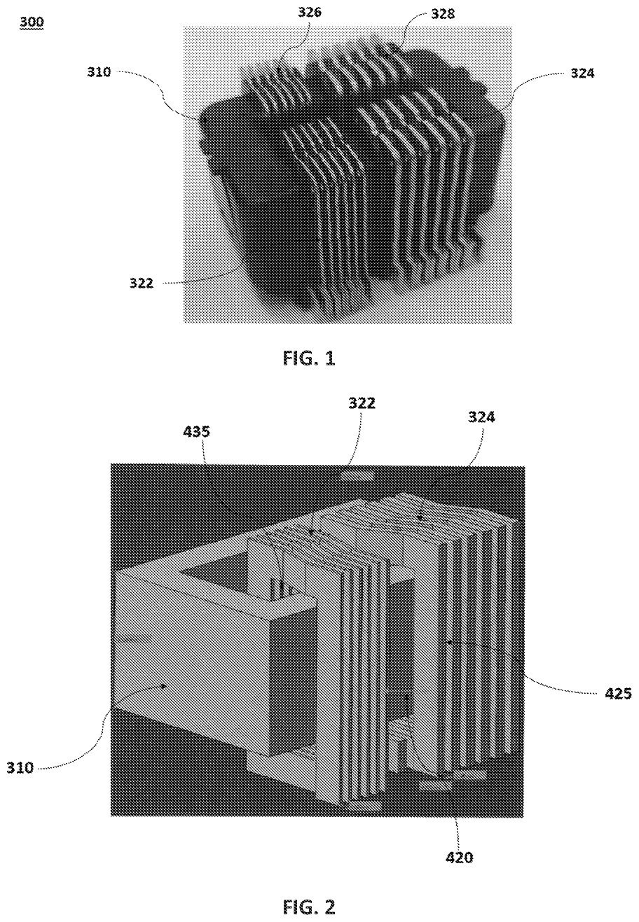

FIG. 1 illustrates an example orthogonal plate toroidal winding assembly 300 according to some embodiments. The assembly 300 may include a core 310 and a plurality of winding plates including first to fourth groups of winding plates 322-328. The core 310 size and cross-sectional aspect ratio can be tuned, modified or customized to match width, height, thickness for each winding, spacings, and assembly volume as required. Each of the groups of winding plates 322-328 can have tight and even spacing between the winding plates or alternatively wide spacing for other desired objectives. The winding plates of the first and third groups 322 and 326 may be spaced apart by a first distance. The winding plates of the second and fourth groups 324 and 328 may be spaced apart by a second distance different from the first distance. The second distance may be greater than the first distance. For example, wider spacing between winding plates can be used when higher voltage isolation is required or greater free convection cooling is thermally desirable. The core 310 may include an air core that comprises any material including gaseous state or vacuum which possesses desired magnetic properties.

Although FIG. 1 shows that each group of the winding plates 322-328 includes six winding plates, the present disclosure is not limited thereto. For example, less than (e.g., 1-5 plates) or more than (e.g., 10-20 plates) six winding plates can be used. Furthermore, the first to fourth groups of winding plates 322-328 can have the same number of winding plates or different numbers of winding plates depending on the embodiment. The first group of winding plates 322 and the third group of winding plates 326 can form one unit. The second group of winding plates 324 and the fourth group of winding plates 328 can form another unit. Although FIG. 1 shows two units, the present disclosure is not limited thereto. For example, the winding assembly 300 can have one winding unit or more than two winding units.

Additional lead or foot connections within each winding unit's start and end may exist for the purposes of electrical connection such as a tap. Additional lead or foot connections existing beyond electrical connections may offer thermal pathways to conduct heat or add strength.

In each side of the core 310, winding plates having different thicknesses can be provided. For example, for the front side of the core 310, the first group of winding plates 322 can be thinner than the second group of winding plates 324, and vice versa. Furthermore, for the rear side of the core 310, the third group of winding plates 326 can be thinner than the fourth group of winding plates 328, and vice versa. Here, the thinner groups of winding plates may conduct less current than the thicker winding plates. The groups of winding plates 322-328 can connect across to other sides of the core 310. The groups of winding plates 322-328 may completely or substantially surround the core 310, which may be of various shapes in addition to rectangular footprint shown.

FIG. 2 is a magnified view of the orthogonal plate toroidal winding assembly 300 of FIG. 1 according to some embodiments. Each of the groups of winding plates 322 and 324 includes an opening 435 through which a portion of the core 310 passes through.

Each of the thinner group of winding plates 322 may have a thickness in a range of about 0.25 mm or greater. Each of the thicker group of winding plates 324 may have a thickness in a range of about 0.50 mm or greater. These thicknesses are merely examples, and the present disclosure is not limited thereto. For example, each of the thinner winding plates 322 can have a thickness less than about 0.25 mm. Furthermore, each of the thicker winding plates 324 can have a thickness less than about 0.50 mm. In some embodiments, a winding plate can be thickened by double stacking two or more thinner plates then joining for desired electrical and thermal functions. The first and last winding plates can have different dimensions for connection purpose whereas the middle winding plates can have the same dimension. For example, the first and last winding plates can be longer, wider and/or thicker while the middle winding plates may be comparatively recessed.

The thinner group of winding plates 322 and the thicker group of winding plates 324 can be spaced apart from each other in the range of about 0.5 mm to about 4 mm-5 mm (see spacing “420” in FIG. 2). Two neighboring ones of each of the thinner winding plates 322 and each of the thicker winding plates 324 can be spaced apart in the range of about 0.5 mm to about 1 mm-2 mm (see spacing “425” in FIG. 2). Spacing between adjacent ones of the thinner group of winding plates 322 can be the same as or different from adjacent ones of the thicker group of winding plates 324. The spacing can be used to adjust a certain electrical property such as capacitance. For example, less spacing between winding plates can create less capacitance, increase voltage surface creepage or clearance. The above spacing ranges are merely examples, and the present disclosure is not limited thereto.

The winding assembly 300 may have a core sectional aspect ratio in the range of about 0.5 to about 1.5. The core sectional aspect ratio can be defined as the height of the cross section of the core 310 over the width of the cross section of the core 310. The above core sectional aspect ratio ranges are merely examples, and the present disclosure is not limited thereto. For example, a core sectional aspect ratio less than about 0.5 or greater than about 1.5 is also possible.

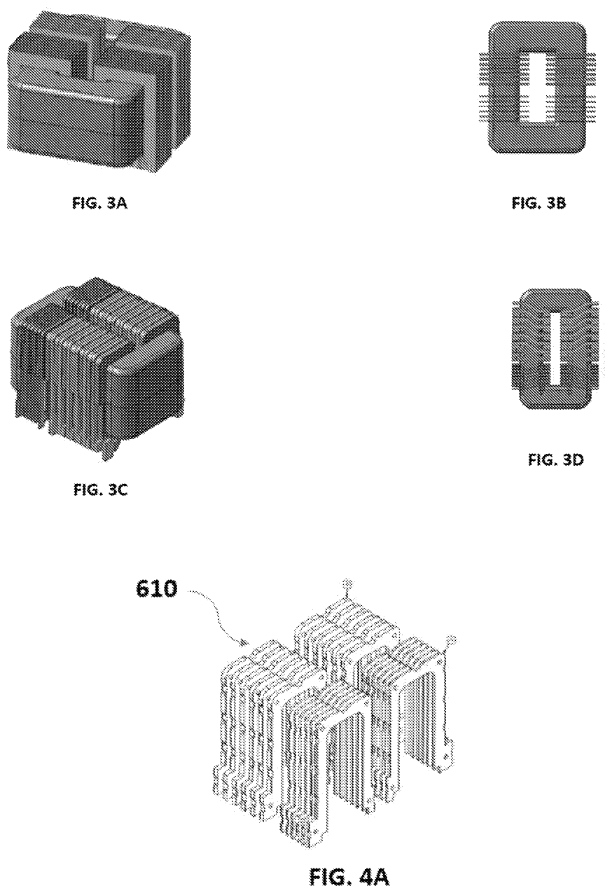

FIGS. 3A-3D illustrate another example orthogonal plate toroidal winding assembly according to some embodiments. FIGS. 3A and 3C show an example orthogonal plate toroidal winding assembly having an inserted orthogonal winding design. FIG. 3B show a top view of FIG. 3A. FIG. 3D shows a bottom view of FIG. 3C.

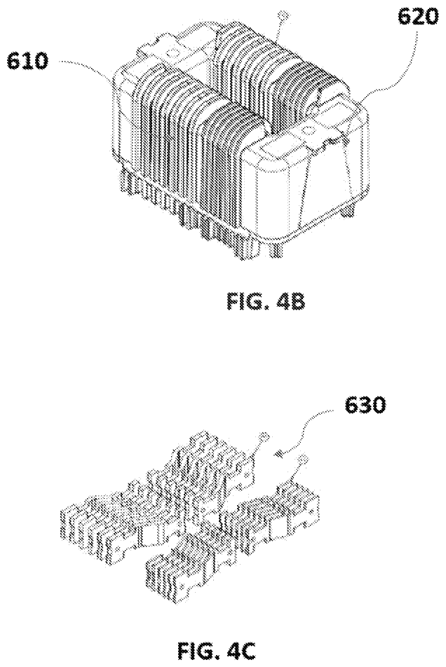

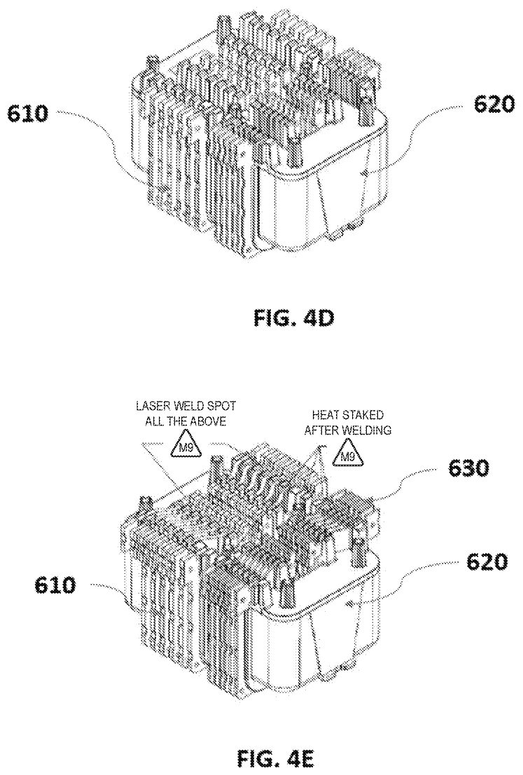

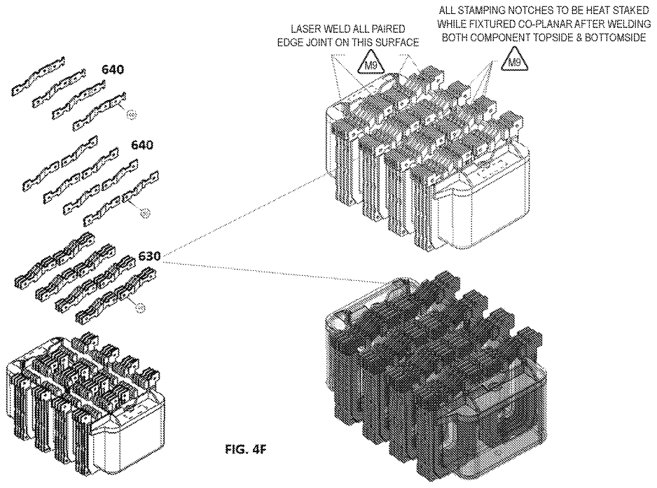

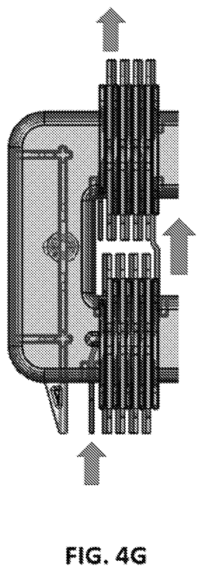

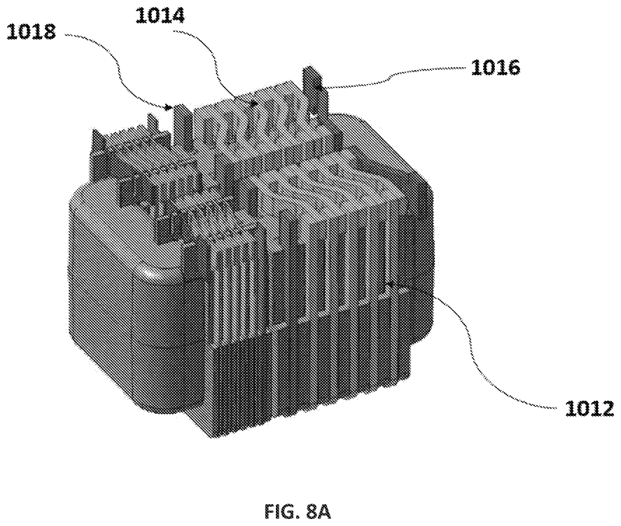

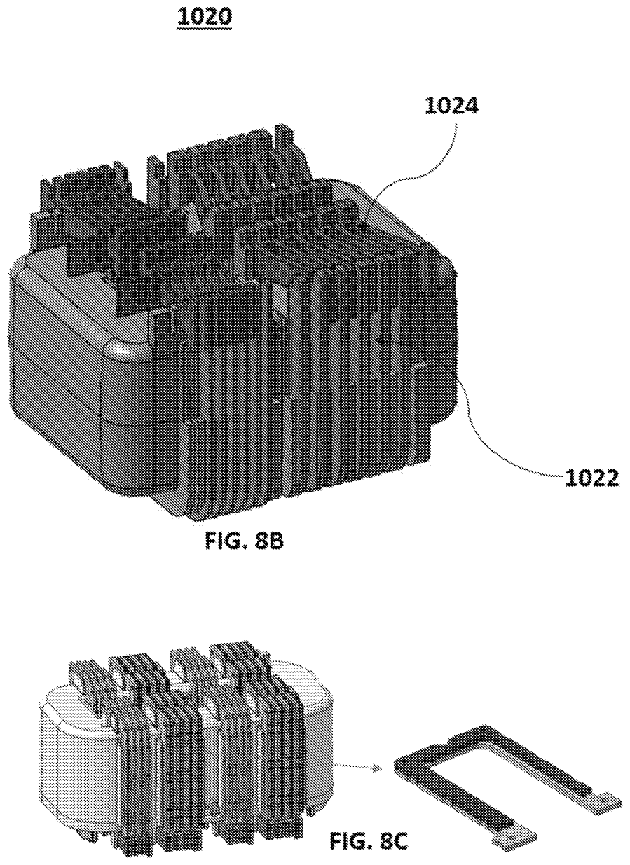

FIGS. 4A-4G illustrate how plates are combined with a core housing to form a core winding assembly according to some embodiments. FIG. 4A shows substantially U-shaped plates 610 according to some embodiments. FIG. 4B shows that the substantially U-shaped plates 610 are placed on a core housing 620. FIG. 4C shows substantially I-shaped plates 630 according to some embodiments. FIG. 4D shows a bottom view of the core winding assembly shown in FIG. 4B. FIG. 4E shows that the substantially I-shaped plates 630 are placed on the bottom portion of the core winding assembly shown assembled to core and housing in FIG. 4D. FIG. 4F shows a more detailed view of how the substantially I-shaped plates 630 are combined into the bottom portion of the core winding assembly shown in FIG. 4D for connection to many or all of the U-shaped plates. In FIGS. 4F, 8 winding units of U-shaped and I-shaped plates are shown. Winding units across on opposite sides of the core may be joined electrically to unify into one larger winding unit which may be double the number of turns for example. In FIG. 4F, reference numeral 640 represents cross-over bus bars or stampings. FIG. 4G is an example of a cross-over stamping which can link windings or conductive elements from one side of the core to another. This cross-over may also be shaped to connect winding units along the same side of the core such as in a split winding. This cross-over may be shaped or used in multiple to branch from one winding unit to multiple other winding units perhaps even linking to winding units primarily wound on another core. The numbers and unique features of the bus bars forming an I-shaped plate shown in FIGS. 4A-4G are merely examples, and the present disclosure is not limited thereto.

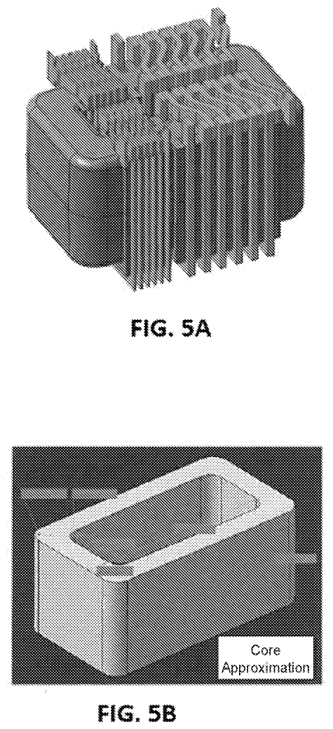

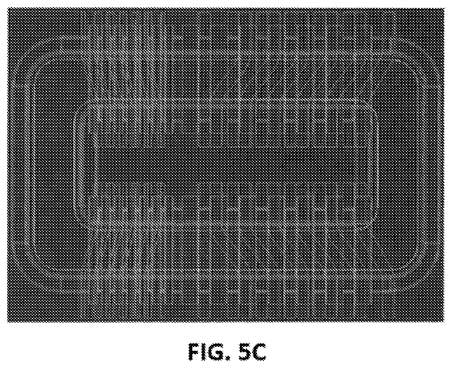

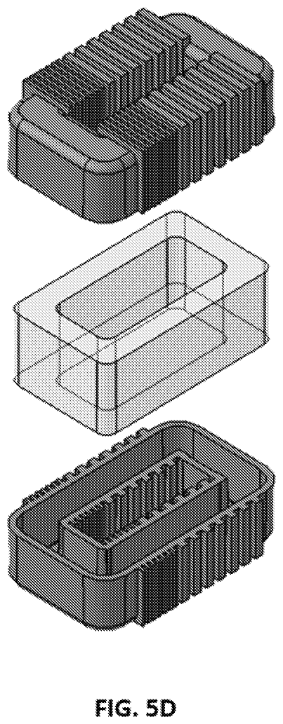

FIGS. 5A-SD are different views of the core winding assembly of FIG. 3D according to some embodiments. FIG. 5C is a wireframe view of the core winding assembly of FIG. 5A according to some embodiments. The core winding assembly shown in FIG. SA is substantially the same as that of FIG. 4E. FIG. 5D shows a cover covered by a core housing that includes a core comb. FIG. SB is an empty core without a housing. FIG. SC is a top view of the core winding assembly of FIG. 5A.

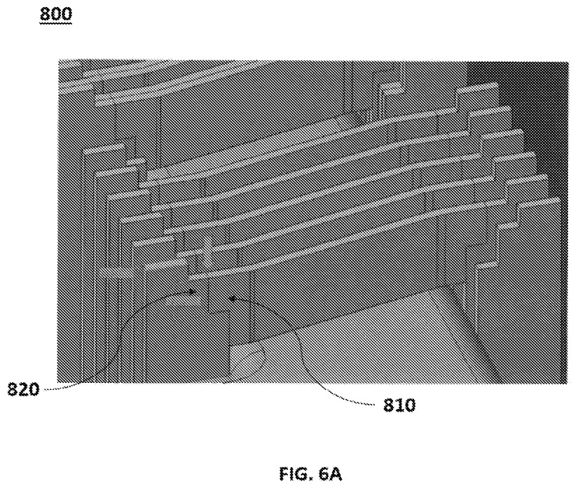

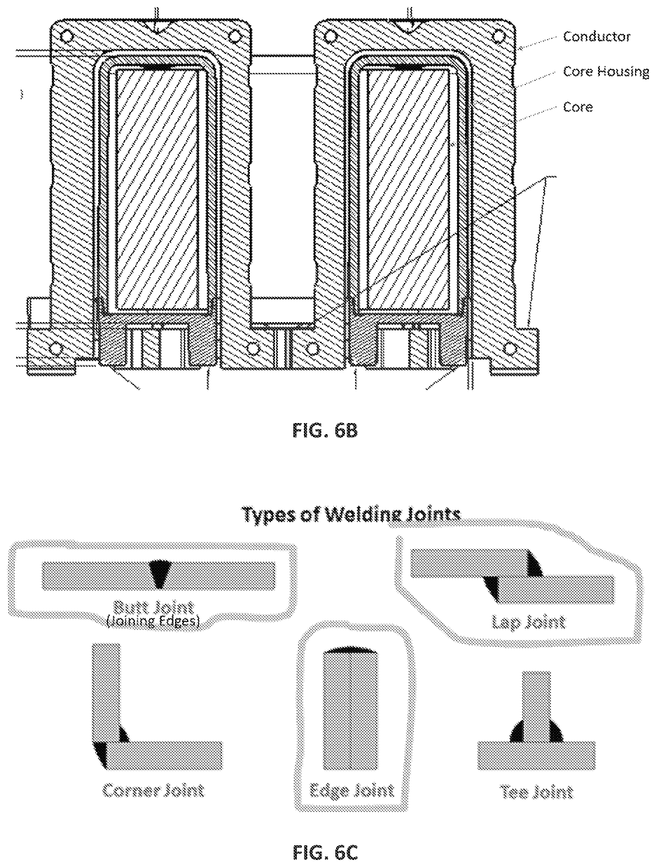

FIG. 6A illustrates an example winding assembly 800 including alternative butt weld joints where the plates are combined. according to some embodiments. FIG. 6 shows a [symbol] shaped edge 810 or a [symbol] shape edge 820 compared to a linear edge shown in FIG. 2. In FIG. 6A, since the plate having [symbol] shaped edge 810 and the plate having the [symbol] shape edge 820 plate overlap in joint portions, this design can offer a thinner joining of the plates. Since the joint portions can be made thinner (e.g., about half) than those of FIG. 5A, spacing between the plates can be reduced resulting in possible winding unit size reductions.

FIG. 6B illustrates a sectional image for an example conversational, spatial understanding core, housing, U-busbar tight fitment. FIG. 6C illustrates example types of welding joints according to some embodiments. In FIG. 6C, for metal plate joining reference, multiple joint types are possible. Types of welding joints shown in FIG. 6C are merely examples, and the present disclosure is not limited thereto.

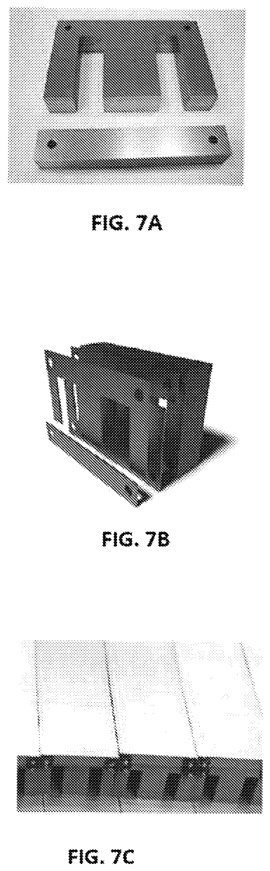

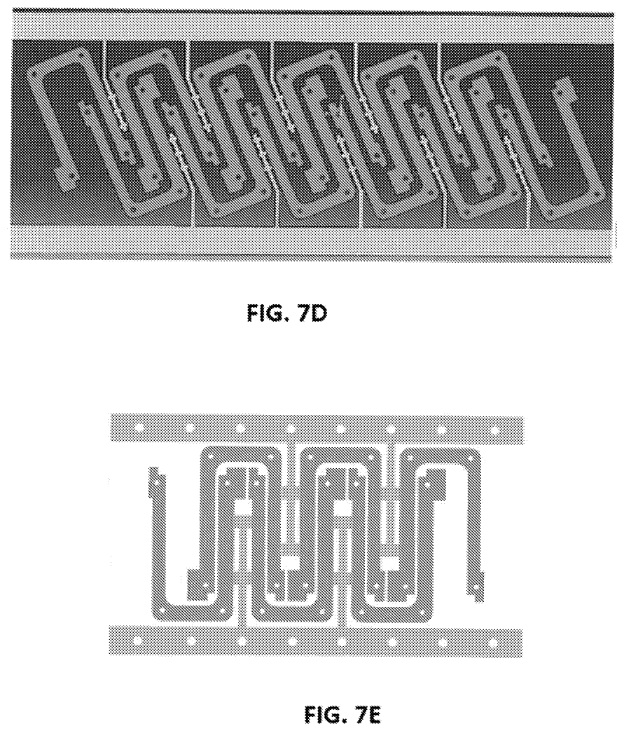

FIGS. 7A-7C illustrate example existing plate stamping formats used to make magnetic cores for industrial familiarity and similar handling reference purposes. FIGS. 7D and 7E illustrate another example progressive stamping formats according to some embodiments intending to optimize material usage. Compared to those plates of FIGS. 7A-7C that are individually made, the plates shown in FIGS. 7D and 7E show an example of progressive stamping arrangements on raw sheet conductor material. FIG. 7D has a slanted nesting design and FIG. 7E shows a vertical design.

FIG. 8A and SB illustrate example orthogonal plate toroidal winding assemblies 1010 and 1020 having different numbers of parts according to some embodiments. The orthogonal plate toroidal winding assembly 1010 of FIG. SA includes four more parts per winding unit than the perpendicular plate toroidal winding assembly 1020 shown in FIG. 8B. For example, the winding assembly 1010 of FIG. 8A includes a U-shape plate 1012, an I-shape plate 1014, a side plate 1016, and a side plate 1018 per winding. In the FIG. SA example, the side plate 1016 has a height different from those of the U-shape plate 1012, the I-shape plate 1014, and the side plate 1018. 1016 and 1018 protrude further from surrounding windings for the purpose establishing a dedicated mounting plane. In the winding assembly 1020 of FIG. 8B, each combined plate includes a U-shape plate 1022 and an I-shape plate 1024. In the FIG. 8B example, the combined plates have the same height. As two more parts (plates) are needed per winding in the FIG. 8A example, the FIG. SA assembly would need four more plates than the FIG. 8B example. FIGS. 8A and 8B merely show example winding assemblies and example numbers of reduced parts, and the present disclosure is not limited thereto.

FIG. 8C illustrates that conductor stampings may be augmented by stacking and connecting other stampings which may be partial or fully sized to double or multiply local current ampacity, reduce electrical resistance, and enhance thermal pathways for the conductor according to some embodiments. These doublers may be optional with stamped windings for higher ampacity, lower resistance, and thermal conduction.

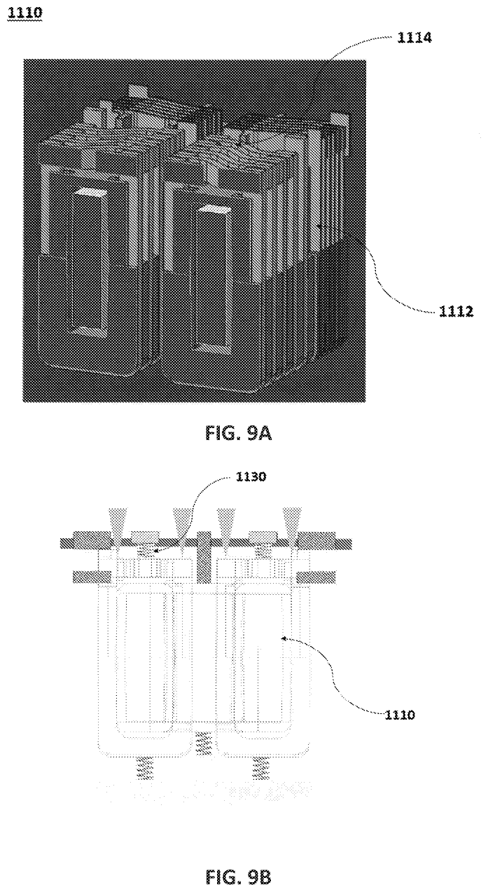

FIGS. 9A and 9B illustrate an example welding method for welding the plates of an example orthogonal plate toroidal winding assembly 1110 according to some embodiments. FIG. 9A shows assembled plates where a U-shape plate 1112 and an I-shape plate 1114 are coupled to each other. The plates 1112 and 1114 can be coupled via welding. The joining method may include various types including, but not limited to, laser welding, higher temperature soldering, ultrasound (ultrasonic), or resistance welding. However, the present disclosure is not limited thereto, and other coupling method can also be used.

FIG. 9B shows a laser welding fixture where an upper spring 1130 can be used to perform fine positioning of the plates 1112 and 1114 of the winding assembly 1110 prior to welding. FIG. 9B shows merely an example positioning fixture and other fine positioning devices can also be used. For example, the upper spring 1130 can be omitted and instead gravity may be adequate to position the plates 1112 and 1114.

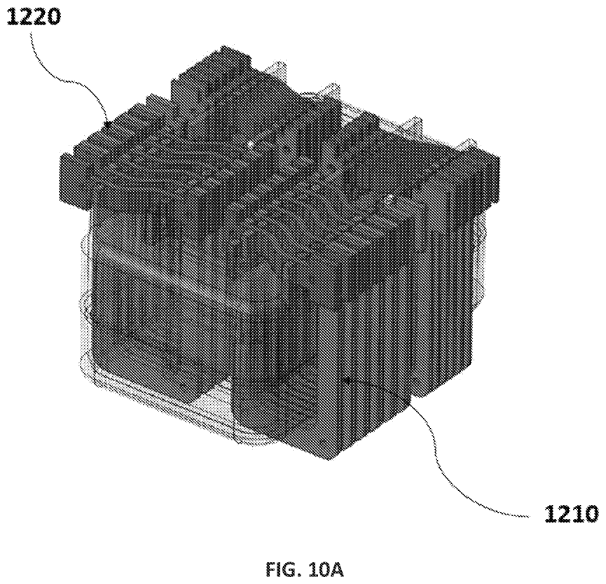

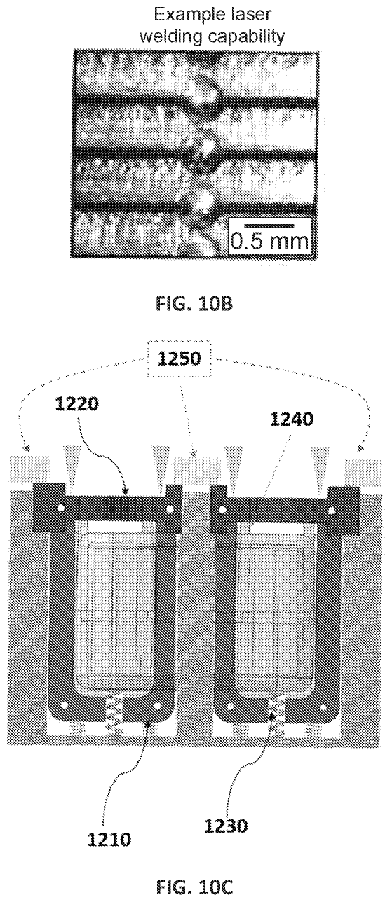

FIGS. 10A-10C illustrate another example welding method for welding the plates according to some embodiments. FIG. 10A shows assembled plates where a U-shape plate 1210 and an I-shape plate 1220 are coupled to each other. FIG. 10B shows example laser welding spot capability showing that even if surfaces of the plates are not smooth or contain slight gap, welding can be performed. In FIG. 10C, the I-shape plate 1220 can be positioned adjacent to the top of the U-shape plate 1210 or features on the core housing held in position by fixture without the use of an upper spring whereas a lower spring 1230 can be used to push core and I-shape plates upwards to mate flush with upper fixture plates 1250.

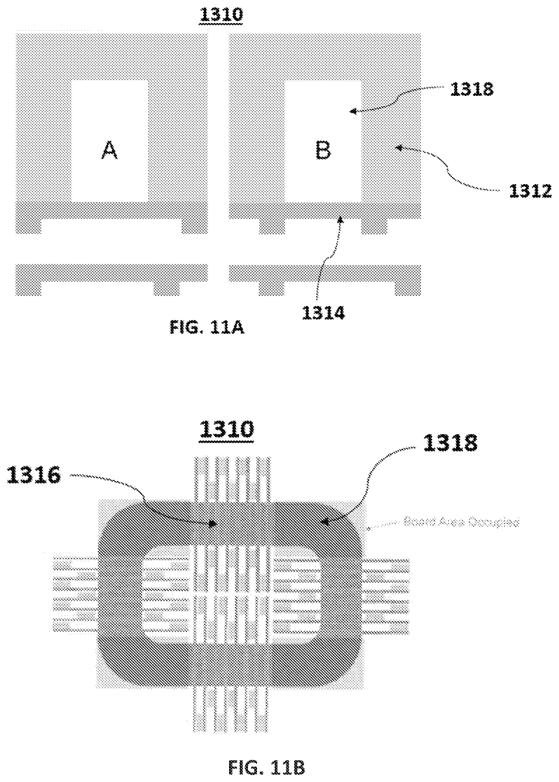

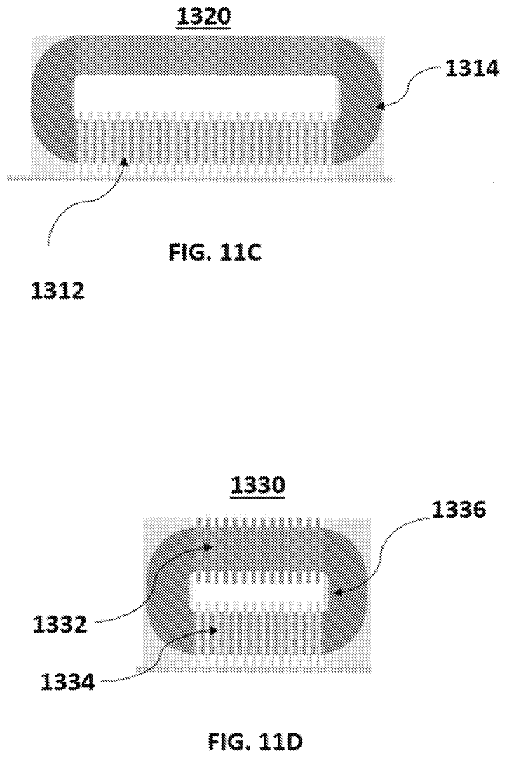

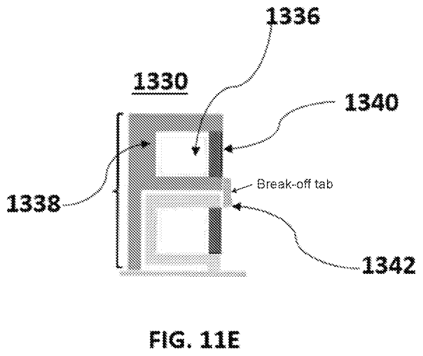

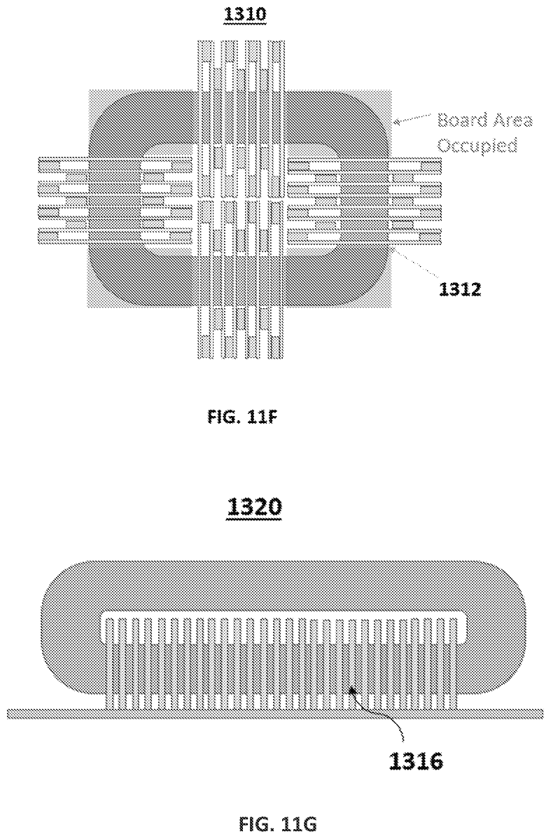

FIGS. 11A and 11B illustrate another example orthogonal plate toroidal winding assembly 1310 according to some embodiments. FIG. 11B shows a top view of the orthogonal plate toroidal winding assembly 1310 of FIG. 11A. In FIG. 11A and FIG. 11B, the U-shape plate 1312 and the I-shape plate 1314, that surround a core 1318, are separated by a film or a sheet insulator 1316. The film or sheet insulator 1316 can be disposed between the plates 1312 and 1314 to avoid a short circuit by insulating adjacent plates. The winding assembly 1310 is similar to the winding assembly 800 shown in FIG. 6A except that in FIG. 11A and FIG. 11B, the film or sheet insulator 1316 is additionally provided.

FIG. 11C illustrates a comparative example core winding assembly 1320 having a winding 1312 disposed in only one side of a core 1314.

FIG. 11D illustrates another example orthogonal plate toroidal winding assembly 1330 according to some embodiments. The example assembly 1330 of FIG. 11C includes windings 1332 and 1336 disposed in both sides of a core 1336.

FIG. 11E is a cross-sectional view of the orthogonal plate toroidal winding assembly 1330 of FIG. 11D according to some embodiments. FIG. 11E indicates stampings may be unified for handling & assembly may also be disconnected from one another later by removal of a break-off tab or other chosen cutting method for individualized electrical function. The orthogonal plate toroidal winding assembly 1330 includes a U-shape plate 1338 and an I-shape plate 1340. The orthogonal plate toroidal winding assembly 1330 may also include a break-off tab 1342 that is used to attach the U-shape plate 1338 and the I-shape plate 1340 for handling during assembly.

FIGS. 11F and 11G are respectively enlarged views of FIGS. 11B and 11C.

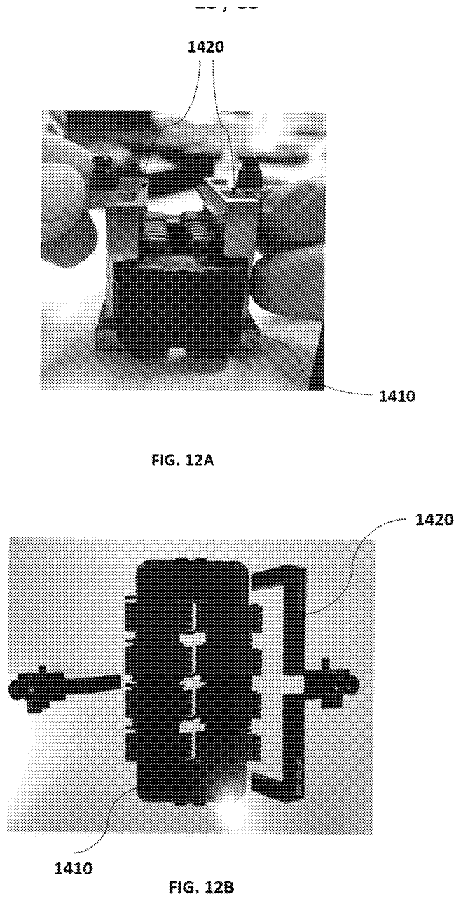

FIGS. 12A and 12B show how an example orthogonal plate toroidal winding assembly is gripped by a gripper 1420 according to some embodiments. Surfaces may be substantially flat or contain other features for example to assist self-alignment, clamping, fastening, lifting, or identification marking. The gripper can be an SMD gripper. The SMD gripper may grip the core or winding or any combination. Both end side surfaces of the core housing may be substantially flat or enhanced with features for lifting or positioning during clamping or lifting or setting into position.

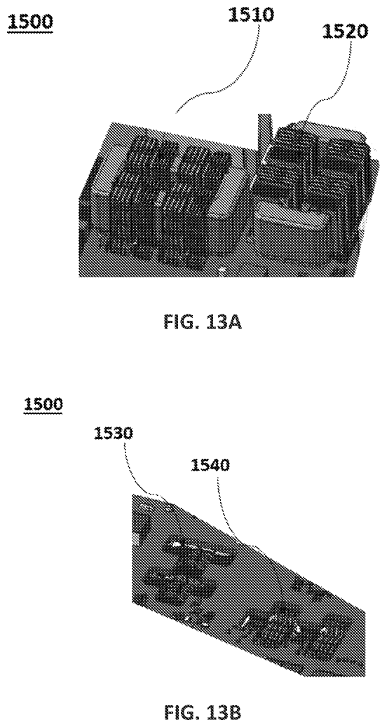

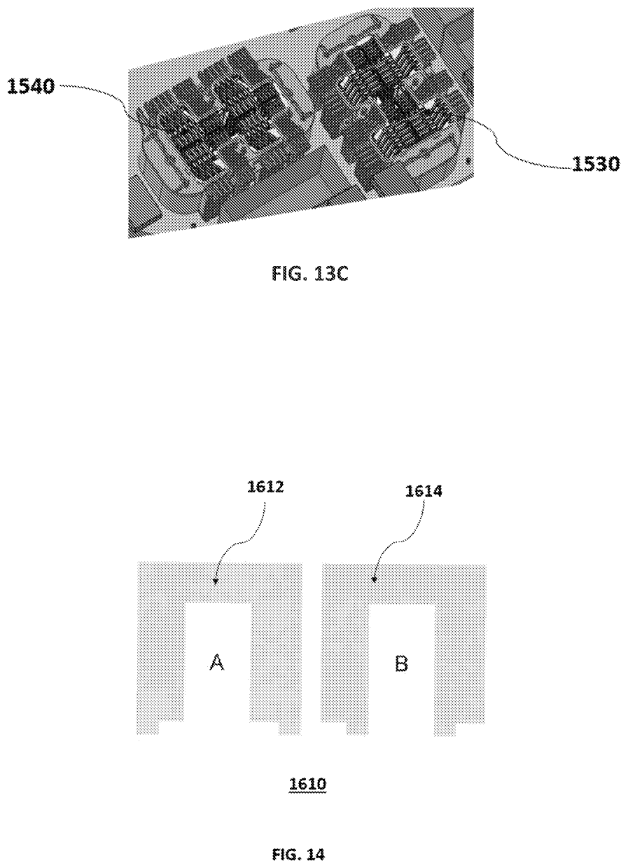

FIGS. 13A and 13B show an example PCB layout 1500 where example orthogonal plate toroidal winding assemblies are disposed according to some embodiments. FIG. 13A is a top view of the PCB layout 1500 including example orthogonal plate toroidal winding assemblies 1510 and 1520. FIG. 13B is a bottom view of the PCB layout 1500 including cutouts (or openings) 1530 and 1540 that can be used as pathways for placement of structures, thermal interface materials, or air passages to cool perpendicular plate toroidal winding assemblies such as the assemblies 1510 and 1520 by thermally dissipating heat generated in the winding assemblies 1510 and 1520 therethrough. FIG. 13C shows a portion of FIG. 13B where transparent PCB view and heat dissipation cutouts are highlighted according to some embodiments.

FIG. 14 illustrates another example orthogonal plate toroidal winding assembly 1610 including a staggered lead design according to some embodiments. The orthogonal plate toroidal winding assembly 1610 includes plates 1612 and 1614 that have staggered protrusions which may serve as electrical connection leads with respect to each other. The plates 1612 and 1614 are similar to those of the winding assembly 800 shown in FIG. 6A or the winding assembly 1310 shown in FIG. 11B in that staggered plates are provided. The plates 1612 and 1614 can respectively include laser welding portions forming a loop (A, B) that alternate during assembly and manufacturing to provide distance between mounting and welding points to prevent incidental electrical shorting between winding turns.

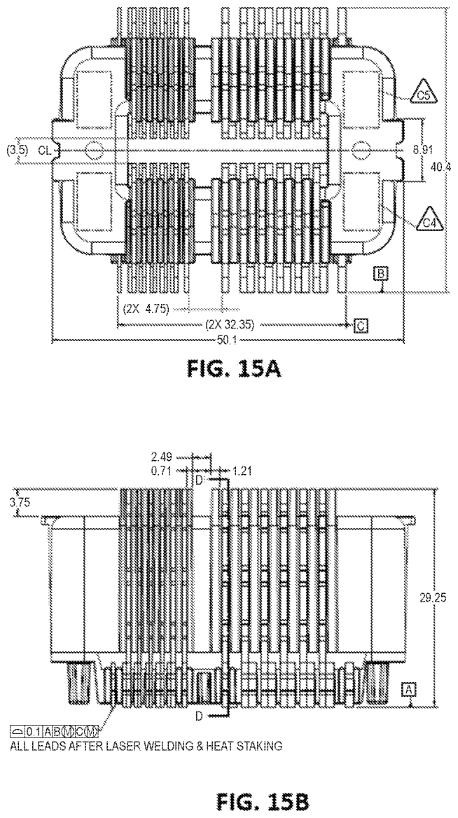

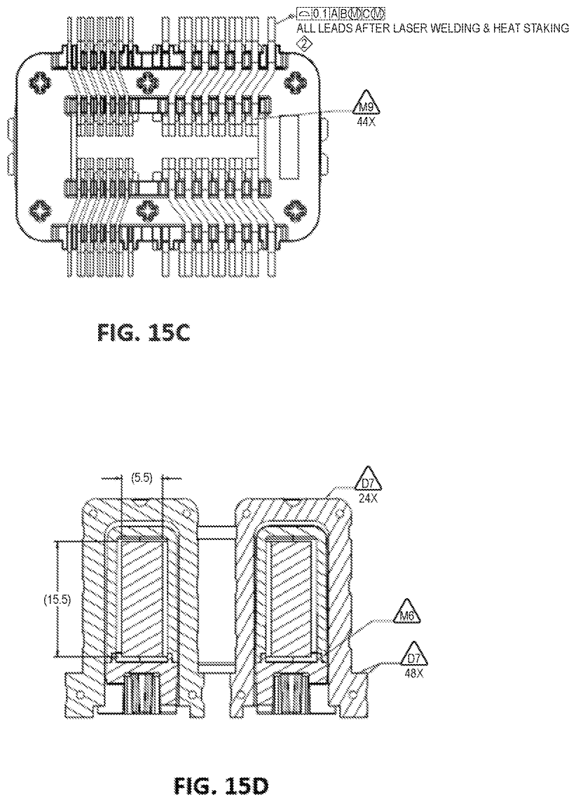

FIG. 15A is a top view of an example orthogonal plate toroidal winding assembly as viewed atop a PCB according to some embodiments. FIG. 15B is a side frontal view of the perpendicular plate toroidal winding assembly of FIG. 15A according to some embodiments. FIG. 15C is a bottom view of the orthogonal plate toroidal winding assembly of FIG. 15A according to some embodiments. FIG. 15D is a sectional view, and FIG. 15E is an end view of the perpendicular plate toroidal winding assembly of FIG. 15A according to some embodiments.

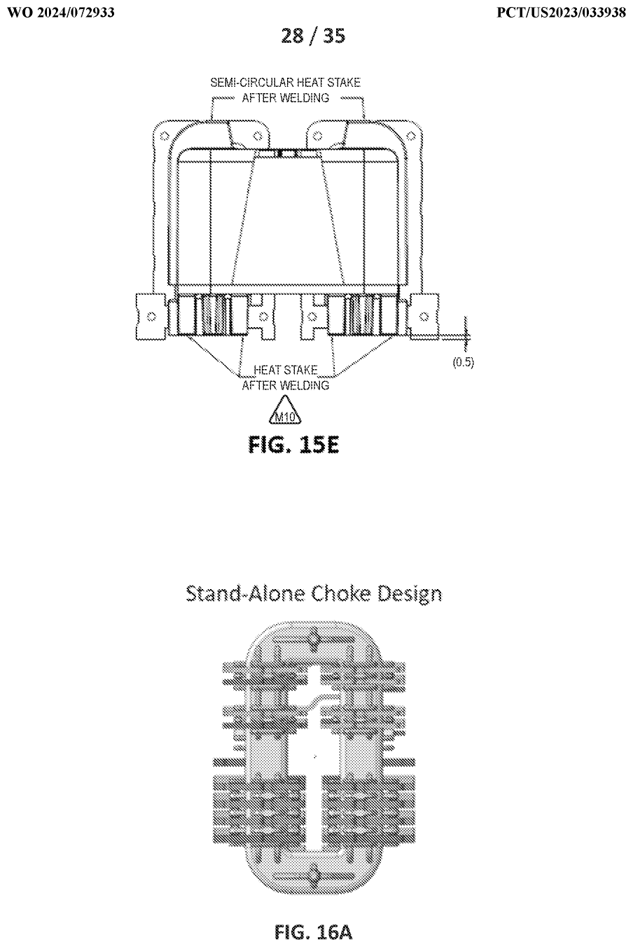

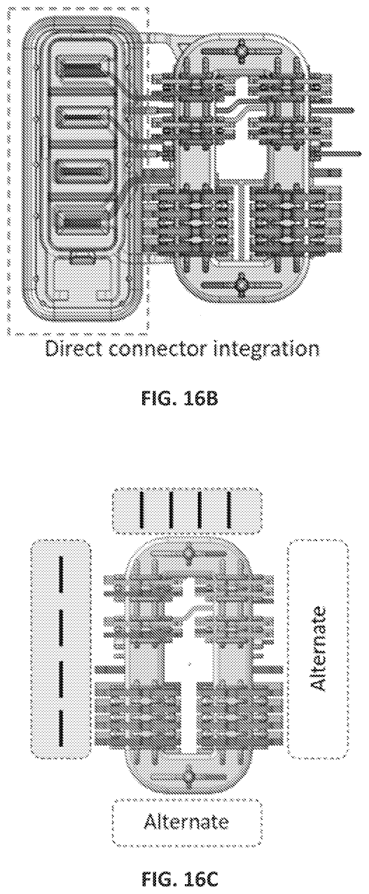

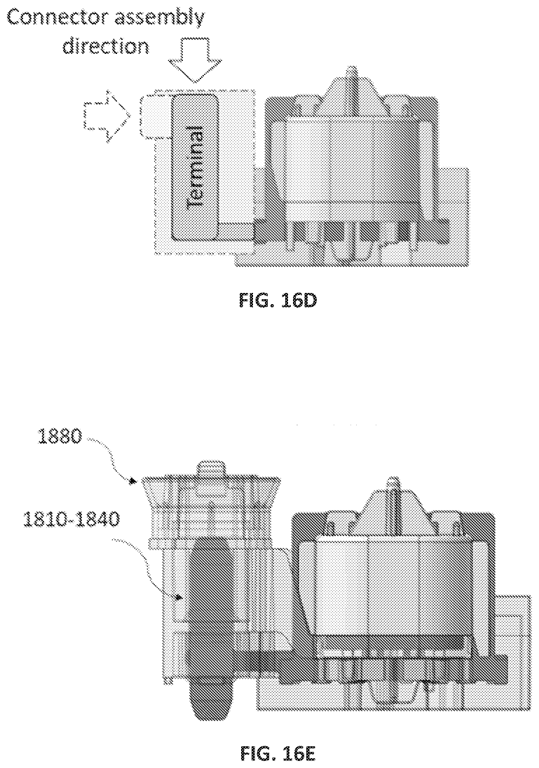

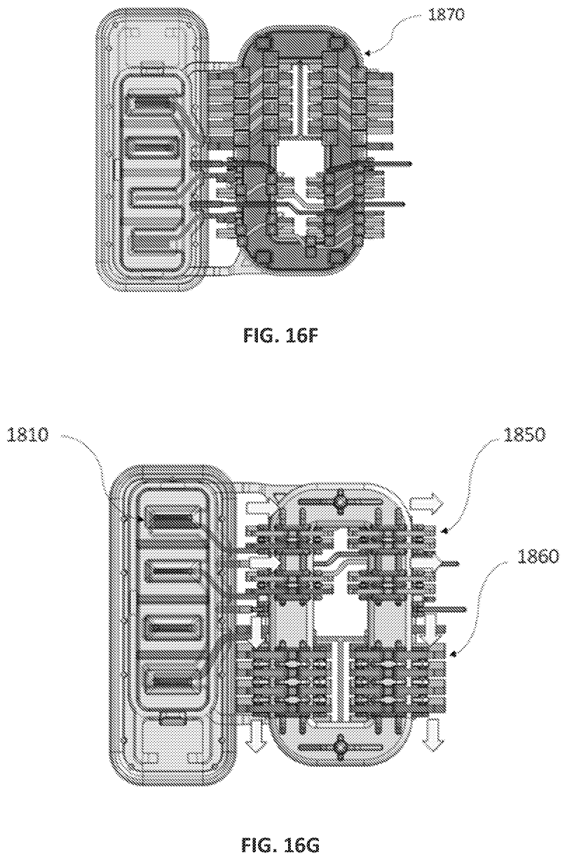

FIG. 16A illustrates a standalone choke design according to some embodiments. FIGS. 16B-16D illustrate how a connector is integrated into the orthogonal plate toroidal winding assembly according to some embodiments. FIG. 16B has an actual application shown with the insert molded busbars that are acting as the connector terminals. These are directly welded to the main orthogonal stamped windings. FIG. 16C has alternative connector positions shown on either side of the choke depending on the embodiment. The terminal orientation can be rotated so that it is either aligned towards the center (see FIG. 16B), or as FIG. 16C shows depending on the mating connector preference. FIG. 16D shows how the installation direction can be adjusted as needed if the integration requires exposing terminals or assembly direction in orthogonal axes compared to the embodiments described above.

FIG. 16E illustrates busbars that are used as connector terminals integrated into the housing by insert molding according to some embodiments. FIG. 16F illustrates an internal ribbon based nanocrystalline core embedded inside the enclosure according to some embodiments. FIG. 16G illustrates how to adjust the way the power flows across the choke in the orthogonal stamping according to some embodiments. FIG. 16E shows purple busbars that are used as connector terminals insert molded in the housing. Reference numerals 1810-1840 indicate 4 stampings. Reference numeral 1850 represents a thin stamped busbar (e.g., U-busbar) which can be used to carry light amperage currents. The thin stamped busbar 1850 can be made of a sheet metal. A thickness of the thin sheet metal 1850 can be about 0.8 mm. Reference numeral 1870 represents a thick stamped busbar (e.g., U-busbar) which can be used to carry higher amperage currents. The thick stamped busbar 1860 can be made of a sheet metal. A thickness of the thick sheet metal 1860 can be about 1.3 mm. The above thicknesses of the busbars 1850 and 1860 are merely examples and other thicknesses may also be used. Reference numeral 1870 represents a nanocrystalline ribbon core which can be an inductor core (shown in dark gray) in FIG. 16F. The nanocrystalline ribbon core 1870 can be constructed from a wound nanocrystalline ribbon. Reference numeral 1880 represents a gasket that is directly molded on the housing to act as a dust seal to the enclosure of a product and seal the internal volume from the external world.

FIG. 16G shows that with the orthogonal stamping, the way the power flows across the choke can be adjusted easily. In FIG. 16G, windings are split across the centerline, the upper windings act similar to FIG. 4G where power flows from left to right. In FIG. 16G, in the bottom two windings shown in (orange), the windings are adjusted to ensure that the power flow direction is aligned along the vertical direction 90 degrees orthogonal to the two windings directly north shown in teal. This integration allows for maintaining the number of windings while minimizing the overall footprint driven by high voltage creepage.

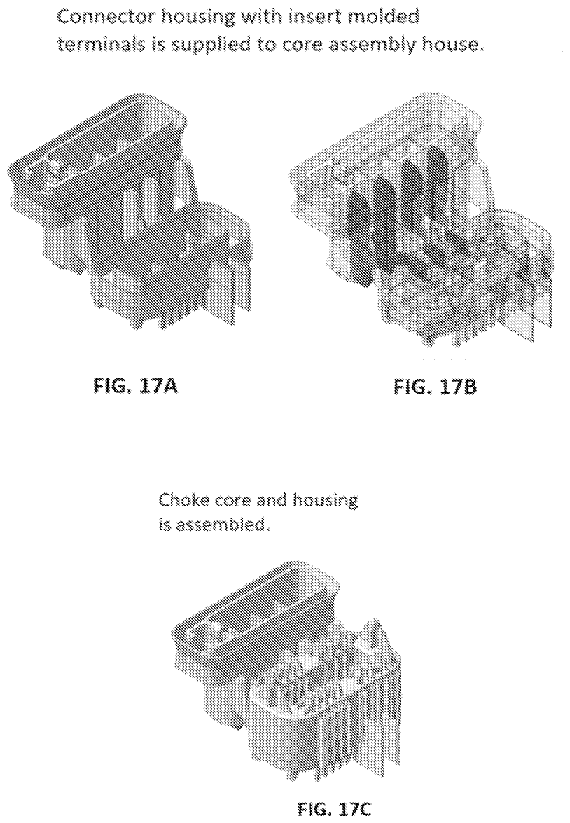

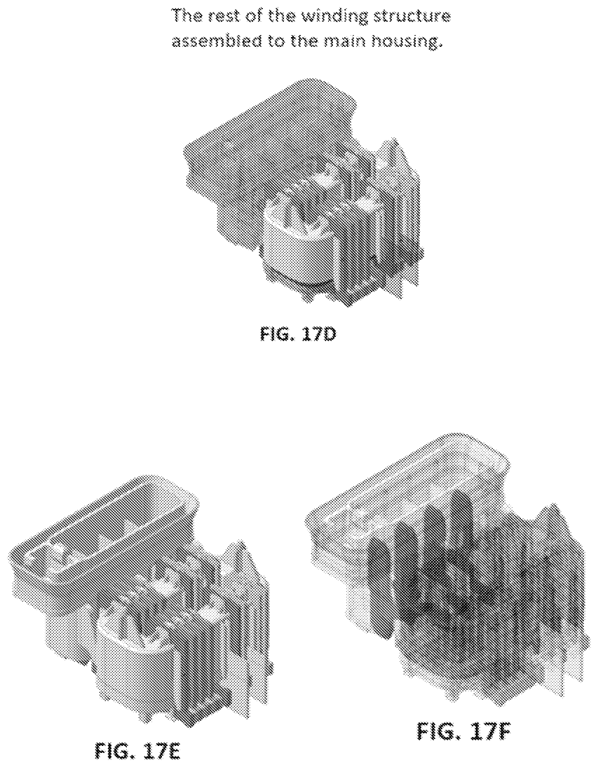

FIG. 17A and FIG. 17B illustrate how the connector housing with insert molded terminals is supplied to the core assembly housing according to some embodiments. FIG. 17C illustrates how the choke core and the housing are assembled according to some embodiments. FIGS. 17D-17F illustrate how the rest of the winding structure is assembled to the main housing according to some embodiments. FIGS. 17A-17F show that the connector-choke integration can be implemented with two assemblies that may be welded together. For example, the two assemblies include a connector housing with insert molded terminals (FIGS. 17A and 17B) and the secondary half that encloses the choke core and aligns the remaining stampings and welding operations (FIGS. 17C-17F). The main advantages of this integration include integrating the connector and optimizing the flow of power as it flows in and out of the connector. Furthermore, integrating the connector terminals allows direct current path from the connector to the choke and does not make contact with the PCBA as needed. This design can also significantly reduce the overall footprint of the choke and improve layout density (power density) using these parts. Easier connector integration as stamped construction of busbars can lend itself to more integrated solutions for blade style connectors.

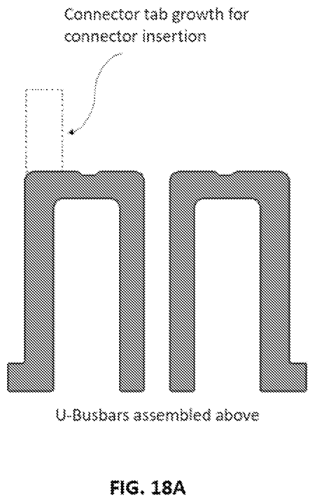

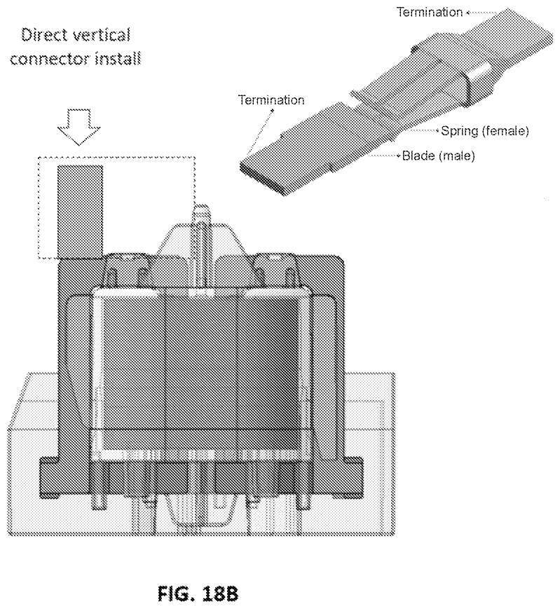

FIG. 18A shows U-busbars assembled (where a connector tab growth for connector insertion is to be installed) according to some embodiments. FIG. 18B shows U-busbars installed directly over the core assembly housing according to some embodiments. Some embodiments provide easier integration of the connector without requiring one or more of an intermediary part to convert a circular profile wire, an obround profile bar to a blade for connector mating, soldering, crimping, or insulation displacement to bite through the varnished dielectric coating. FIG. 18B uses a stamped bus bar construction for the windings to provide a much easier/more efficient integration since the male blade for connectors that are traditionally stamped can be stamped directly on the windings. In some embodiments, the geometry of the U-Busbars can be modified to add the interfaces directly on them if spacings allow.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

1. An electromagnetic core and winding assembly, comprising:
a core comprising a body and an aperture defined by an inner surface of the body; and
a plurality of plate windings configured to electromagnetically operate with the core, the plurality of plate windings disposed to cross and at least partially surround the body of the core, a portion of each of the plurality of plate windings passing through the aperture of the core, wherein at least one of the plate windings has sections of electrical or thermal conductor attached in parallel to current flow to increase ampacity, reduce resistance, and/or improve thermal distribution or dissipation.

2. The assembly of claim 1, wherein the plurality of plate windings perpendicular to equatorial plane of core at least partially surround the body of the core.

3. The assembly of claim 1, wherein the plurality of plate windings fully surround the body of the core.

4. The assembly of claim 1, further comprising a core housing accommodating the core therein, the core housing comprising a plurality of perpendicular grooves formed on an external surface thereof, the plurality of perpendicular grooves configured to respectively accommodate the plurality of plate windings therein.

5. The assembly of claim 1, wherein each of the plurality of plate windings comprises a first plate comprising two opposing ends and at least partially surrounding the body of the core and a second or more plates configured to couple to the two opposing ends of the first plate in serial chained arrangement with other like plates.

6. The assembly of claim 5, wherein the first plate has a substantially U shape and the second plate has a substantially I shape.

7. The assembly of claim 1, wherein the plurality of plate windings are substantially U-shaped or contoured to surround a cross-sectional shape of the core.

8. The assembly of claim 1, wherein the plurality of plate windings comprise one or more first groups of plate windings surrounding a first side of the body of the core and one or more second groups of plate windings surrounding a second side of the body of the core opposing the first side.

9. The assembly of claim 1, wherein the one or more first groups of plate windings comprise a first group and a second group spaced apart from each other, wherein the first group comprises a first number of plate windings, and wherein the second group comprises a second number of plate windings

10. The assembly of claim 9, wherein the first number and the second number are the same.

11. The assembly of claim 9, wherein the first number and the second number are different.

12. The assembly of claim 9, wherein at least one of the first group of plate windings or the second group of plate windings comprise one of a plurality of plates evenly spaced apart from each other and a plurality of winding plates spaced apart from each other in a range of about 0.5 mm to about 1 mm-2 mm.

13. The assembly of claim 9, wherein the first group of plate windings are spaced apart from the second group of plate windings in a range of about 0.5 mm to about 4 mm-5 mm.

14. (canceled)

15. (canceled)

16. The assembly of claim 9, wherein the first group of plate windings comprise a plurality of plates spaced apart from each other by a first distance, and wherein the second group of plate windings comprise a plurality of plates spaced apart from each other by a second distance different from the first distance.

17. The assembly of claim 9, wherein at least one of the plate windings of the first group has a thickness different from at least one of the plate windings of the second group.

18. The assembly of claim 1, wherein at least one of the plates has bent features or additionally attached elements, including those used for connecting winding assembly, configured to extend for one or more of thermal, mechanical, or electrical connection, or other functional purposes.

19. (canceled)

20. The assembly of claim 1, wherein the plates are configured to join or branch winding units along same side, other sides, or opposite sides of the main core or other core winding unit(s) to be electrically connected.

21. The assembly of claim 1, wherein the core comprises any material including gaseous state or vacuum which possesses desired magnetic properties.

22. The assembly of claim 1, further comprising a plurality of connector terminals coupled to the plurality of plate windings, wherein the core and the plurality of plate windings are accommodated in a housing, and wherein the plurality of connector terminals are integrated into the housing by insert molding.

23. (canceled)

24. The assembly of claim 1, wherein the core has a cross section, having a core aspect ratio defined as a length of the cross section of the core over a width of the cross section of the core, and wherein the core aspect ratio is varying.
